(19) United States
(12) Patent Application Publication
(10) Pub. No.: US 2026/0031254 A1
(43) Pub. Date: Jan. 29, 2026

(54) Phone charge lanyard with a buckle

(71) Applicant: Daisy Wo Yee LAU, Hong Kong (CN)

(72) Inventor: Daisy Wo Yee LAU, Hong Kong (CN)

(21) Appl. No.: 19/279,658

(22) Filed: Jul. 24, 2025

(30) Foreign Application Priority Data
Jul. 25, 2024 (HK) 32024094688.1

(51) Int. Cl. H01B 7/40; A45F 5/00; H01R 13/73

(52) U.S. Cl. CPC H01B 7/40; A45F 5/00; H01R 13/73; A45F 2005/006

(57) ABSTRACT

A phone charge lanyard with a buckle, comprising a buckle and a charge lanyard goes through the buckle, two ends of the charge lanyard are respectively provided with a charge connector I and a charge connector II, a wire is laid along the charge lanyard and connects with the charge connector I and the charge connector II; the charge connector I and/or the charge connector II are provided with a plug, the plug is provided with a loop, the loop slide along the charge lanyard, the length of the charge lanyard is adjusted by sliding the loop along.

### FIELD OF THE INVENTION

The present invention involves the field of a lanyard and its lanyard buckle, specially a phone charge lanyard with a buckle.

### BACKGROUND OF THE INVENTION

A lanyard buckle is a small and practical accessory, typically used to connect various items (such as keys, phone cases, card holders, small tools, USB drives, etc.) to a lanyard for easy carrying or wearing. A lanyard is a common accessory or practical tool, usually made from fabric, nylon, leather, or other materials. One end provides a loop or other mechanism to secure items, while the other end is the cord part designed for wearing.

The traditional phone lanyard is generally only used for carrying phones or keys. The phone charging cable is often stored in bags or clothing pockets. When a phone needs charging, user has to search through their bag or pocket, complexing the charging process. Furthermore, when people are working outdoors, they would prefer to use a phone lanyard to carry their phone to prevent loss. However, when it is necessary to charge the phone, they still need to rummage through a backpack or bag for the charging cable, making the method of carrying and charging a phone quite inconvenient.

Therefore, there is an urgent need for a lanyard buckle and charging lanyard that are easy to carry and offer a simple charging method.

### SUMMARY OF THE INVENTION

To overcome the drawbacks of the aforementioned existing technologies, the purpose of the present invention is to provide a lanyard buckle and its charging lanyard for easily carrying and offering a simple charging method.

The technical solution is as follow: a phone charge lanyard with a buckle, wherein comprising a lanyard buckle and a charging lanyard threaded through the lanyard buckle, a charging connector I and a charging connector II are respectively provided at both ends of the charging lanyard, with a wire embedded inside and connecting charging connector I and charging connector I; connector caps are fitted to the charging connector I and/or the charging connector II, and a loop is provided on one side of the connector cap, with the loop slidably arranged on the charging lanyard.

Furthermore, a corresponding end of the charging lanyard which is threaded through the lanyard buckle is bent and overlapped, and a fixing component is provided at the bent and overlapped section to restrict and secure the bent and overlapped part of the charging lanyard.

Furthermore, two rope holes are arranged parallelly in the fixing member, through which the bent and overlapped charging lanyard is respectively passed; one of the rope holes is provided with an opening slit on a sidewall to facilitate inserting the charging lanyard into the rope hole from the sidewall thereof.

Furthermore, the lanyard buckle comprises an outer ring and an inner ring; the outer ring is rotatably sleeved on the outside of the inner ring; the outer ring has a first notch, and the inner ring is provided with at least one buckling slot;
while locking, the first notch of the outer ring and the buckling slot of the inner ring are misaligned, with the outer ring sealing the buckling slot;
while unlocking, the first notch of the outer ring and the buckling slot of the inner ring are aligned.

Furthermore, the inner ring provides a second notch;
while locking, the first notch of the outer ring and the second notch of the inner ring are misaligned, with the outer ring sealing the second notch;
while unlocking, the first notch of the outer ring and the second notch of the inner ring are aligned.

Furthermore, the inner ring is provided with a threading hole in the middle section for threading the charging lanyard.

Furthermore, the outer ring has a toggle protrude for actuating the outer ring; the toggle protrude is a trapezoidal protrusion.

Furthermore, the charging connector II is connected to the buckling slot through a connecting piece; the charging connector I is connected to the buckling slot or passes through the threading hole to connect with the inner ring.

Furthermore, the connecting piece includes a sleeve and a plug interconnected; the charging connector II is set in the sleeve, and the plug is thread connected to the sleeve.

Furthermore, the lanyard buckle also comprises a fastening plate for connecting to a mobile phone; the fastening plate is connected to the buckling slot through a locking ring; a shaft is provided between the fastening plate and the locking ring, and the locking ring is thread connected to the shaft through a threaded post; the locking ring is inserted into the outer ring through the first notch of the outer ring and is then positioned within the buckling slot of the inner ring for fixation.

The benefits of the present invention are:

1. Adjust the loop on the charging lanyard by sliding it to fix and adjust the length of the charging lanyard.

2. Insert charging connector I or II into the phone's charging port, then manually slide the connector upwards to pull the connector I out of the connector cap. Then, you can insert charging connector I into the charger which is simpler and more convenient. When the sleeve and plug are closed through thread connection, the whole charging cable forms a lanyard that can be worn or carried, further providing convenience for phone portability.

3. When the fastening plate is placed on the charging opening of the phone case, thread connects the locking ring and the shaft. User can then carry the phone by holding the inner ring and outer ring. Additionally, the trapezoidal protrusion of the outer ring blocks the locking ring to prevent components on the outer ring from disengaging.

### BRIEF DESCRIPTION OF THE DRAWINGS

FIG. 1 is a schematic structural diagram of Embodiment 1 in the present invention.

FIG. 2 is a schematic perspective structural diagram of another embodiment in the present invention.

FIG. 3 is a schematic diagram of the present invention while the connector cap is separated from charging connector I.

FIG. 4 is a schematic diagram of the fixing component and charging lanyard in the present invention.

FIG. 5 is a schematic diagram of the connector cap and the fixing component in the present invention.

FIG. 6 is a schematic diagram of components such as the charging lanyard, charging connector I, and charging connector II in Embodiment 2 of the present invention.

FIG. 7 is an exploded view of another embodiment in the present invention.

FIG. 8 is a schematic diagram of the present invention while the inner ring and outer ring are separated.

FIG. 9 is a schematic diagram of another embodiment of the inner ring and outer ring in the present invention.

FIG. 10 is a schematic diagram of the present invention while the sleeve and plug are separated.

FIG. 11 is a schematic diagram of the present invention while the locking ring and shaft are separated.

In figures above: 1. the charging lanyard, 2.the outer ring, 3. the inner ring, 4. the first notch, 5. the buckling slot, 6. the second notch, 7.the threading hole, 8.the toggle protrude, 9. the charging connector I, 10.the charging connector II, 11.the sleeve, 12. the plug, 13. the fixing component, 14. the rope holes, 15. the opening slit, 16. the connector cap, 17. the loop, 18. the fastening plate, 19. the locking ring, 20. the shaft, 21.the threaded post

### DESCRIPTION OF THE EMBODIMENTS

The ideas, specific structures, and technical effects produced by the present invention will be clearly and completely described below in conjunction with the embodiments and accompanying drawings, in order to fully understand the objectives, solutions, and effects of the present invention. It should be noted that, where there is no conflict, the embodiments in this application and the features within the embodiments can be combined with each other. Should be noted that, unless otherwise specified, when a feature is referred to as being “fixed” or “connected” to another feature, it can be directly fixed or connected to the other feature, or it can be indirectly fixed or connected to the other feature. Furthermore, descriptions such as “upper,” “lower,” “left,” “right,” “top,” and “bottom” used in the present invention are merely relative to the positional relationships of the various components of the present invention in the accompanying drawings.

Moreover, unless otherwise defined, all technical and scientific terms used herein have the same meaning as commonly understood by one of the ordinary skill in the art to which this technology belongs. The terminology used in this specification is merely for describing particular embodiments and is not intended to limit the present invention. The term “and/or” as used herein includes any combination of one or more related listed items.

It should be understood that, although terms such as first, second, third, etc., may be used in this disclosure to describe various elements, these elements should not be limited by these terms. These terms are used only to distinguish elements of the same type from each other. For example, without departing from the scope of this disclosure, a first element could also be referred to as a second element, and similarly, a second element could also be referred to as a first element.

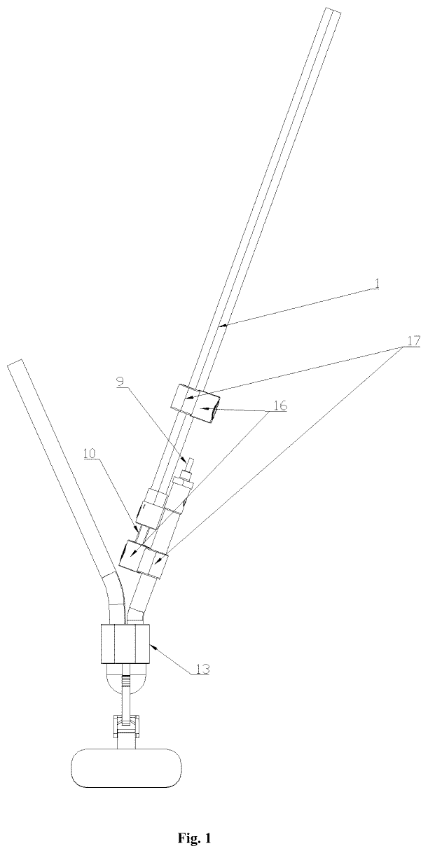

Embodiment 1: a phone charging lanyard with a buckle, as shown in FIG. 1, the exterior of the charging lanyard 1 is made of nylon braided material, with one end of the charging lanyard 1 bent and overlapped. The charging connector I 9 and the charging connector II 10 are respectively located at the two ends of the charging lanyard 1, with the wire embedded inside the charging lanyard 1 to electronically connect the charging connector I 9 and the charging connector II 10. Both of the charging connector I 9 and the charging connector II 10 are fitted with a connector cap 16. A loop 17 is provided on one side of the connector cap 16, which is slidably positioned on the charging lanyard 1. The connector cap 16 can slide along the charging lanyard 1 through the loop 17. By sliding and adjusting the loop 17 on the charging lanyard 1, the length of the charging lanyard 1 can be fixed and adjusted. The connector cap 16 can also shelter the charging connector I 9 and the charging connector II 10 on the charging lanyard 1 to ensure their lifespan. Simultaneously, both the connector cap 16 and the loop 17 are made of silicone. When use, they can cooperate with the nylon braided material on the exterior of the charging lanyard 1 to increase friction between them, thereby preventing the charging lanyard 1 from easily slipping off. When the two ends of the charging lanyard 1, namely the charging connector I 9 and the charging connector II 10, are connected by the connector cap 16 and loop 17 to form a whole lanyard for being used as a wearable carrying item.

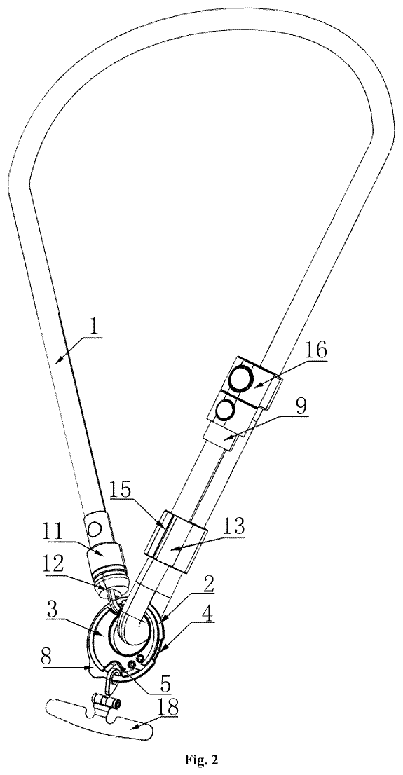

Embodiment 2: a phone charging lanyard with a buckle, as shown in FIG. 2, the exterior of the charging lanyard 1 is made of nylon braided material, with one end of the charging lanyard 1 bent and overlapped. The charging connector I 9 and the charging connector II 10 are respectively located at the two ends of the charging lanyard 1, with wire embedded inside the charging lanyard 1 to electronically connect the charging connector I 9 and the charging connector II 10. A connector cap 16 is fitted onto either the charging connector I 9 or the charging connector II 10. A loop 17 is provided on one side of the connector cap 16, which is slidably positioned on the charging lanyard 1. The connector cap 16 can slide along the charging lanyard 1 through the loop 17. By sliding and adjusting the loop 17 on the charging lanyard 1, the length of the charging lanyard 1 can be fixed and adjusted. The connector cap 16 can also shelter the charging connector I 9 and the charging connector II 10 on the charging lanyard 1 to ensure their lifespan. Simultaneously, both the connector cap 16 and the lanyard loop 17 are made of silicone. When use, they can cooperate with the nylon braided material on the exterior of the charging lanyard 1 to increase friction between them, thereby preventing the charging lanyard 1 from easily slipping off. When one of the charging connectors (the charging connector I 9 or the charging connector II 10) of the charging lanyard 1 is connected through the connector cap 16 and the loop 17, the other charging connector is connected to components like the lanyard buckle through a connecting piece. This allows the charging lanyard 1 to form an whole lanyard that can be used as a wearable carrying item.

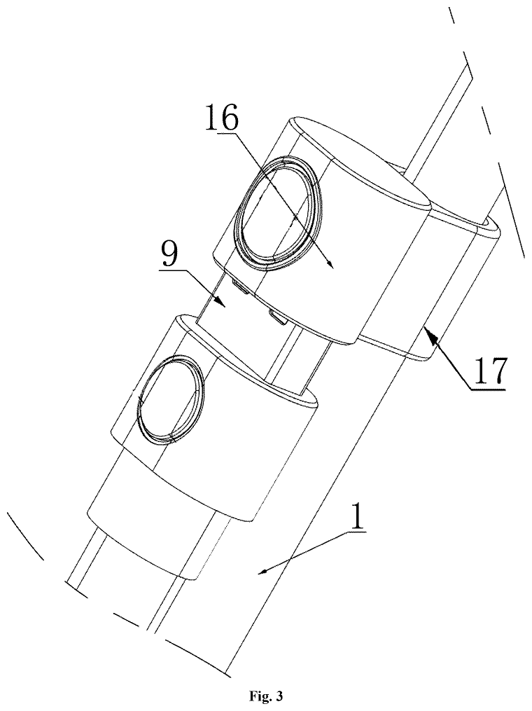

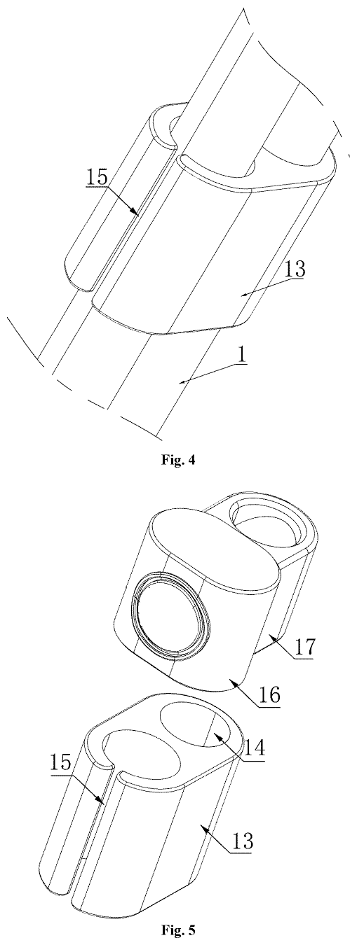

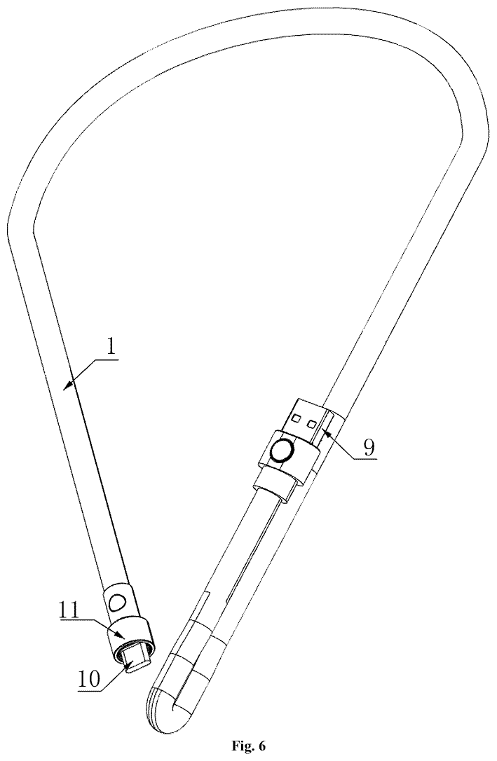

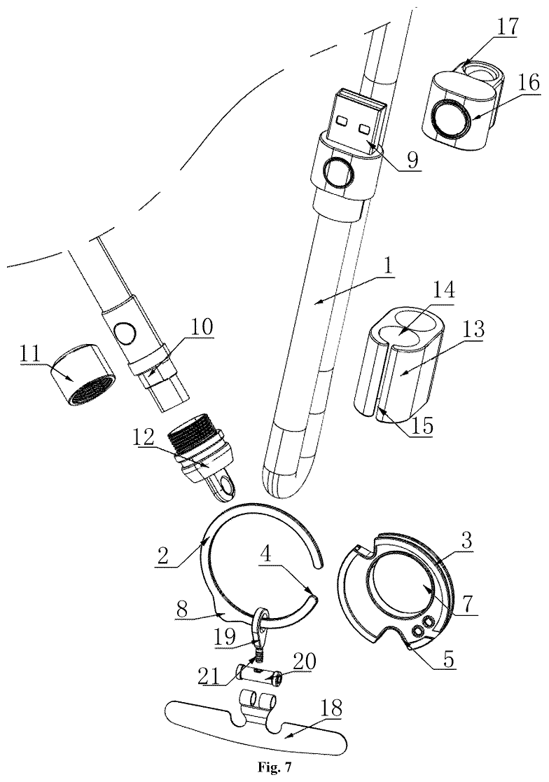

Embodiment 3: based on Embodiment 1 or 2, as shown in FIG. 1-7, a fixing component 13 is also included. The fixing component 13 is positioned at the bent and overlapped section of the charging lanyard 1 to fix the bent and overlapped section of the charging lanyard 1. The fixing component 13 is made of silicone. When in use, it works with the nylon braided material on the exterior of the charging lanyard 1 to increase friction between them, further preventing the charging lanyard 1 from slipping off. The fixing component features two rope holes 14 arranged parallelly, through which the folded and overlapped charging lanyard passes. One of the rope holes 14 has an opening slit 15 on its sidewall, designed to easily place the charging lanyard1 into the rope hole 14. This opening slit 15 allows the bent and overlapped section of the charging lanyard 1 to be pulled out when in use, making it easy to remove or adjust the charging lanyard 1.

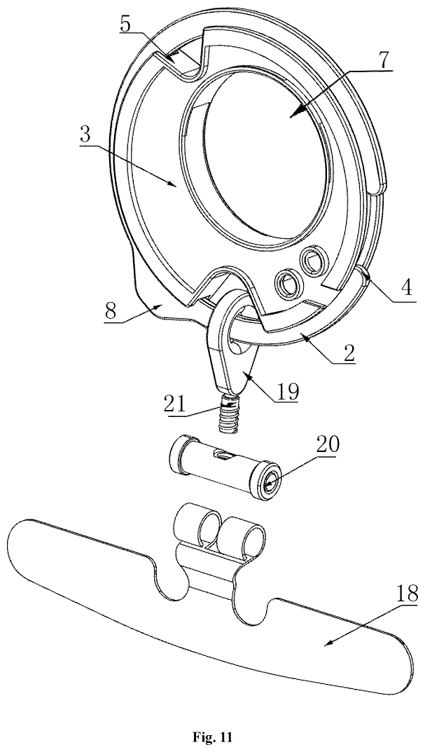

Embodiment 4: a phone charging lanyard with a buckle, as shown in FIG. 1 to FIG. 11, comprises a fastening plate 18, a shaft 20, a locking ring 19, an outer ring 2, an inner ring 3, a plug 12, a sleeve 11, the charging lanyard 1, the charging connector I 9, the charging connector II 10, and the connector cap 16. The fastening plate 18 is an overall fan-blade shaped plate. The top left and right sides of the fastening plate 18 symmetrically feature arc-shaped notches of the same size, making it easy for users to grasp. The upper end of the fastening plate 18 is curved and trapezoidal, with this trapezoidal part being sized to fit a phone's charging port. The locking ring 19 is connected to the upper end of the fastening plate 18. The shaft 20 is provided between the locking ring 19 and the fastening plate 18. The locking ring 19 is thread connected to the shaft 20 through a threaded post 21. The outer ring 2 is sleeved through the locking ring 19. The outer ring 2 is U-shaped. The outer ring 2 has a toggle protrude 8, which is a trapezoidal protrusion. While rotating the outer ring 2, user simply needs to toggle the toggle protrude 8 to lock the locking ring 19 and the outer ring 2. The right side of the outer ring 2 has a first notch 4. The inner ring 3 is rotatably connected to the inner side of the outer ring 2. The inner ring 3 is provided with buckling slots 5. When the inner ring 3 or outer ring 2 is rotated so that the first notch 4 and the buckling slot 5 on both align, a hanging strap or other object can be attached at the first notch 4 for carrying. The inner ring 3 has inwardly concave buckling slots 5 on its upper and lower sides and/or inner side. The threading hole 7 in the middle of the inner ring 3 is eccentric. The space formed by this buckling slot 5 on the lower right side of the inner ring 3 and the outer ring 2 can hold the locking ring 19 inside. The plug 12 is sleeved onto the outer side of the outer ring 2 through its first notch 4 on the right side. The space formed by this buckling slot 5 on the upper left side of the inner ring 3 and the outer ring 2 can hold the plug 12 inside.

The plug 12 is locked in the outer ring 2, with the plug 12 located on the upper left side of the outer ring 2. The upper part of the plug 12 is thread connected to a sleeve 11. The charging lanyard 1 is passed through the middle of the inner ring 3. The exterior of the charging lanyard 1 is made of nylon braided material, and its right portion is the bent and overlapped portion. The wire is embedded inside the charging lanyard 1 to electronically connect the charging connector I 9 and the charging connector II 10. One end of the charging lanyard 1 is equipped with charging connector I 9, while the other end is the charging connector II 10. The charging connector II 10 is located inside the sleeve 11 and is rotatably connected to the sleeve 11. The connector cap 16 is sleeved with the charging connector I 9. One side of the connector cap has a loop 17, which is slidably positioned on the charging lanyard 1. The connector cap 16 can slide along the charging lanyard 1 through the loop 17. The connector cap 16 can also shelter the charging connector I 9 and the charging connector II 10 on the charging lanyard 1 to ensure their lifespan. The loop 17 of the connector cap 16 is slidably positioned on the charging lanyard 1; when the connector cap 16 shelters the charging connector I 9, it also fixes with the charging lanyard 1. The connector cap 16 is made of silicone material. When in use, it works with the nylon braided material on the exterior of the charging lanyard 1 to increase friction, thereby preventing the charging lanyard 1 from easily slipping off. When the plug 12 and the sleeve 11 are locked through thread connection, the whole charging lanyard 1 can be used as a wearable carrying item.

When a user needs to carry his phone, he can first remove the phone case from the back of the phone. The fastening plate 18 is then placed on the inside of the phone case's charging opening, with the upper end of the fastening plate 18 protruding outside the phone case's charging opening. Afterwards, the separated locking ring 19 and shaft 20 can be reconnected by twisting them together through the threaded post 21.

When the user does not carry the phone through the inner ring 3, he just needs to twist and separate the locking ring 19 and shaft 20 again by unscrewing them, and then remove the fastening plate 18 from the phone case.

When a user needs to charge your phone, rotate the inner ring 3 or outer ring 2 to align the buckling slots 5. Make sure the toggle protrudes on the outer ring 2 does not block the locking ring 19. Next, slip the lower part of the plug 12 into the outer ring 2. Then, rotate the outer ring 2 to lock the lower part of the plug 12 within the buckling slot 5 on its side, preventing it from detaching. Let the charging lanyard 1 pass through the center of the inner ring 3. Now, insert charging connector II 10 into the phone's charging port. Manually hold the connector cap 16 and slide it upward along the charging lanyard 1 to dispose of the charging connector I 9. User can then insert the charging connector I 9 into the charging connector and start charging the phone. Once charging is finished, unplug both charging connector I 9 and the charging connector II 10. Again, hold the connector cap 16 to insert the charging connector I 9 for protection. The fixing component 13 will keep the bent and overlapped section of the charging lanyard 1. Next, hold the charging connector II 10 and twist the sleeve 11 to screw it to the plug 12. This encloses charging connector II 10 within the cavity formed by their connection, further protecting it. Once the sleeve 11 and the plug 12 are threaded connected, the whole charging lanyard 1 forms a lanyard that can be worn or carried, offering even greater convenience for phone portability. The fixing component 13 can further secure the bent and overlapped section of the charging lanyard 1 that's wrapped around the inner ring 3. When user carries the phone using the charging lanyard 1, the fixing component 13 will create friction with its exterior, preventing the right section of the charging lanyard 1 from slipping off.

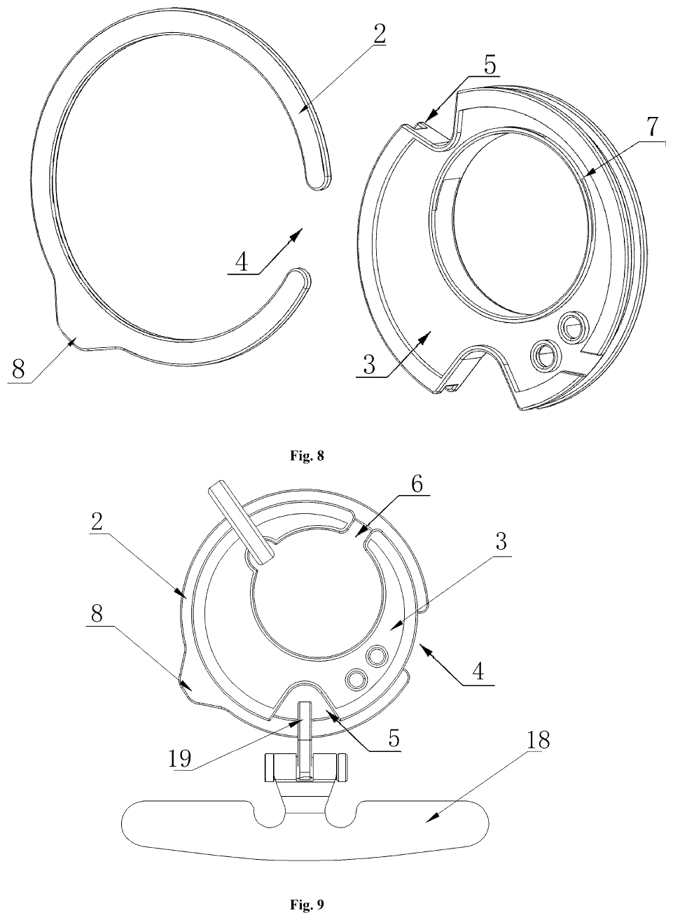

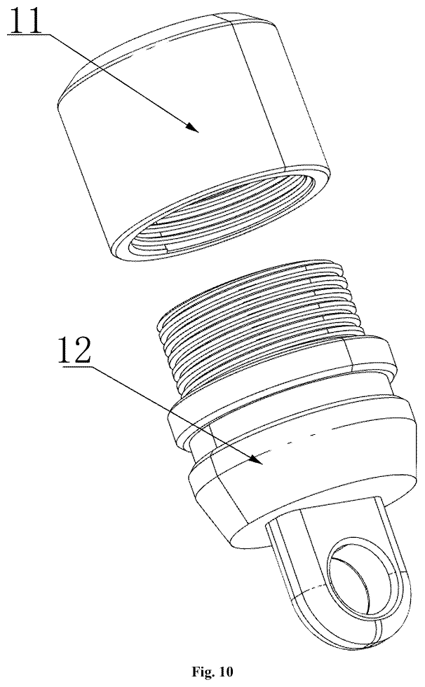

Embodiment 5: as shown in FIG. 9, a second notch 6 is provided on one side of the inner ring 3. A threading hole 7 is located in the middle of the inner ring 3 for passing through the charging lanyard 1. When the inner ring 3 or outer ring 2 is rotated so that the first notch 4 and the second notch 6 on both rings simultaneously rotate to align in the same direction, a lanyard or other items, such as connectors, can be hung and inserted into the inner ring 3 and/or outer ring 2 through the first notch 4 and the second notch 6. Similarly, while locking, simply rotate the inner ring 3 or outer ring 2 so that the first notch 4 and the second notch 6 are staggered, thereby closing the second notch 6 of the inner ring 3 and preventing the internal lanyard or other items from detaching.

So, the user can carry his mobile phone by attaching charging lanyard 1. Due to the cooperative rotation of the inner ring 3 and the outer ring 2, when user needs to attach a tag or the bent and overlapped portion of the charging lanyard 1 into the threading hole 7 of the inner ring 3 for carrying the phone. User simply manually toggle the toggle protruded 8 to rotate inner ring 3 or outer ring 2. When the second notch 6 of inner ring 3 is rotated to align with the first notch 4 of outer ring 2, it is in an unlocked state. Now, the tag or lanyard can be hung through the second notch 6 into the center of inner ring 3. Then, rotate the inner ring 3 or the outer ring 2 again to misalign the first notch 4 and the second notch 6 to prevent the tag or lanyard from disengaging from the thread hole 7 of the inner ring 3.

In addition, based on the above embodiment, the bucking slots 5 of the inner ring 3 are respectively arranged on the inner side and the outer side, as shown in FIG. 9. The bucking slot 5 on the inner side is located on the upper part of the inner ring 3, the bucking slot 5 on the outer side is located on the lower part of the inner ring 3. The connecting piece is locked in the bucking slot 5 on the inner side, and the fastening plate 18 is locked in the bucking slot 5 on the outer side.

The above descriptions are merely preferred embodiments of the present invention. The present invention is not limited to the aforementioned embodiments. Any modifications, equivalent substitutions, improvements, etc., that achieve the technical effects of the present invention by the same means, and are within the spirit and principles of this disclosure, shall be included within the scope of protection of this disclosure. These should all fall within the protection scope of the present invention. Within the protection scope of the present invention, its technical solutions and/or embodiments may have various modifications and variations.

1. A phone charge lanyard with a buckle, wherein comprising a lanyard buckle and a charging lanyard threaded through the lanyard buckle, a charging connector I and a charging connector II are respectively provided at both ends of the charging lanyard, with a wire embedded inside and connecting charging connector I and charging connector I; connector caps are fitted to the charging connector I and/or the charging connector II, and a loop is provided on one side of the connector cap with the loop slidably arranged on the charging lanyard.

2. The phone charge lanyard with a buckle of claim 1, wherein a corresponding end of the charging lanyard which is threaded through the lanyard buckle is bent and overlapped, and a fixing component is provided at the bent and overlapped section to restrict and secure the bent and overlapped part of the charging lanyard.

3. The phone charge lanyard with a buckle of claim 2, wherein two rope holes are arranged parallelly in the fixing member, through which the bent and overlapped charging lanyard is respectively passed; one of the rope holes is provided with an opening slit on a sidewall to facilitate inserting the charging lanyard into the rope hole from the sidewall thereof.

4. The phone charge lanyard with a buckle of claim 1, wherein the lanyard buckle comprises an outer ring and an inner ring; the outer ring is rotatably sleeved on the outside of the inner ring; the outer ring has a first notch, and the inner ring is provided with at least one buckling slot;
while locking, the first notch of the outer ring and the buckling slot of the inner ring are misaligned, with the outer ring sealing the buckling slot;
while unlocking, the first notch of the outer ring and the buckling slot of the inner ring are aligned.

5. The phone charge lanyard with a buckle of claim 4, wherein the inner ring provides a second notch;
while locking, the first notch of the outer ring and the second notch of the inner ring are misaligned, with the outer ring sealing the second notch;
while unlocking, the first notch of the outer ring and the second notch of the inner ring are aligned.

6. The phone charge lanyard with a buckle of claim 4, wherein the inner ring is provided with a threading hole in the middle section for threading the charging lanyard.

7. The phone charge lanyard with a buckle of claim 4, wherein the outer ring has a toggle protrude for actuating the outer ring; the toggle protrude is a trapezoidal protrusion.

8. The phone charge lanyard with a buckle of claim 5, wherein the charging connector II is connected to the buckling slot through a connecting piece; the charging connector I is connected to the buckling slot or passes through the threading hole to connect with the inner ring.

9. The phone charge lanyard with a buckle of claim 8, wherein the connecting piece includes a sleeve and a plug interconnected; the charging connector II is set in the sleeve, and the plug is thread connected to the sleeve.

10. The phone charge lanyard with a buckle of claim 4, wherein the lanyard buckle also comprises a fastening plate for connecting to a mobile phone; the fastening plate is connected to the buckling slot through a locking ring; a shaft is provided between the fastening plate and the locking ring, and the locking ring is thread connected to the shaft through a threaded post; the locking ring is inserted into the outer ring through the first notch of the outer ring and is then positioned within the buckling slot of the inner ring for fixation.
